(19) United States
(12) Patent Application Publication
(10) Pub. No.: US 2020/0047291 A1
(43) Pub. Date: Feb. 13, 2020

(54) Flux and Solder Paste

(71) Applicant: Senju Metal Industry Co., Ltd., Tokyo (JP)

(72) Inventors: Masato Shiratori, Tochigi (JP); Hiroyoshi Kawasaki, Tokyo (JP); Yasuhiro Kajikawa, Tochigi (JP)

(21) Appl. No.: 16/534,420

(22) Filed: Aug. 7, 2019

(30) Foreign Application Priority Data
Aug. 10, 2018 (JP) 2018-151855

(51) Int. Cl. B23K 35/36; B23K 35/362; C08K 5/13

(52) U.S. Cl. CPC B23K 35/3613; B23K 35/3618; C08L 33/00; C08K 5/13; B23K 35/362

(57) ABSTRACT

A flux including: a) a phenolic activator except a hindered phenol, b) a resin, c) an organic acid, and d) a solvent. The phenolic activator, which is contained in the flux, has a molecular weight of 150 or more and 550 or less. Further, the flux may include: a) a phenolic activator except a hindered phenol and b) an acrylic resin.

### CROSS REFERENCE TO RELATED APPLICATION

This application claims priority to Japanese Patent Application No. 2018-151855 filed Aug. 10, 2018, the disclosure of which is hereby incorporated by reference in its entirety.

### BACKGROUND OF THE INVENTION

### (1) Field of the Invention

The present invention relates to a flux used for soldering and a solder paste using the flux.

### (2) Description of Related Art

In general, fluxes used for soldering have effects of chemically removing metal oxides present on solder and the metal surface of a joint target to be soldered and allowing the movement of metal elements at the boundary between the two. Therefore, by soldering using the flux, an intermetallic compound can be formed between the solder and the metal surface of the joint target, so that strong joint can be obtained.

In the flux, organic acids, amines, halogens, and the like are widely used as activators for removing metal oxides.

Also, recently, there has been focused on a flux composition which contains a thermosetting resin represented by an epoxy resin to give an effect equivalent to resin sealing to a resin composition remaining after soldering.

In a flux composition containing an epoxy resin, a curing agent is added to accelerate the curing of the epoxy resin. There has been proposed a technique of making electrical connection, without adding an activator, by using a phenolic compound having an activity of chemically removing metal oxides as such a curing agent (for example, see JP 2002-232123 A). Also for epoxy resin-free fluxes, a composition containing a phenolic compound has been proposed (see, for example, JP H05-42388 A).

However, in a conventional composition containing an epoxy resin and a phenolic compound, it is difficult to achieve both the wetting rate of solder and the aqueous solution resistivity of a flux even when activators such as an organic acid, an amine and a halogen are used in combination. In addition, it is known to use a phenolic compound in a flux which does not contain a thermosetting resin such as an epoxy resin. However, it has conventionally not been considered to achieve both the wetting rate of solder and the aqueous solution resistivity of a flux.

### SUMMARY OF THE INVENTION

The present invention has been made to solve such problems, and an object thereof is to provide a flux which achieves both the wetting rate of solder and the aqueous solution resistivity of the flux, and a solder paste using the flux.

Phenolic activators except a hindered phenol have been found to be active in a temperature range assumed for soldering and to provide a high aqueous solution resistivity.

So, the present invention provides a flux including a phenolic activator having a molecular weight of 150 or more and 550 or less except a hindered phenol, a resin, an organic acid, and a solvent, the phenolic activator except a hindered phenol being contained in an amount of 1 wt % or more and 30 wt % or less; the resin consisting of a rosin and an acrylic resin; the rosin being contained in an amount of 30 wt % or more and 60 wt % or less when the total amount of the flux is 100; the acrylic resin being contained in an amount of 0 wt % or more and 40 wt % or less when the total amount of the flux is 100; the resins being contained in a total amount of 30 wt % or more and 60 wt % or less; and the organic acid being contained in an amount of more than 0 wt % and 10 wt % or less.

It is desirable to provide the flux wherein the weight ratio of the acrylic resin to the entire resin consisting of the rosin and the acrylic resin is preferably 0% or more and 80% or less. Moreover, the phenolic activator except a hindered phenol preferably includes one or more of diallyl bisphenol A, 9,9-bis(4-hydroxy-3-methylphenyl)fluorene and 2,2′,6,6′-tetramethyl-4,4′-(9-fluorenylidene)diphenol.

It is also desirable to provide a flux including a phenolic activator except a hindered phenol, and a rosin and an acrylic resin as resins, the phenolic activator except a hindered phenol being contained in an amount of 1 wt % or more and 30 wt % or less; the acrylic resin being contained in an amount of more than 0 wt % and 40 wt % or less when the total amount of the flux is 100; the resins being contained in a total amount of 30 wt % or more and 60 wt % or less; the weight ratio of the acrylic resin to the entire resin consisting of the rosin and the acrylic resin is 20% or more and 80% or less; and the organic acid being contained in an amount of more than 0 wt % and 10 wt % or less.

It is additionally desirable to provide the flux wherein it is preferable that the rosin be contained in an amount of 30 wt % or more and 60 wt % or less when the total amount of the flux is 100. Moreover, the phenolic activator except a hindered phenol preferably includes one or more of diallyl bisphenol A, 9,9-bis(4-hydroxy-3-methylphenyl)fluorene and 2,2′,6,6′-tetramethyl-4,4′-(9-fluorenylidene)diphenol.

Furthermore, it is desirable to provide the flux preferably further including: 0 wt % or more and 20 wt % or less of an amine; 0 wt % or more and 5 wt % or less of an organohalogen compound or an amine hydrohalic acid salt, or an organohalogen compound and an amine hydrohalic acid salt; and 0 wt % or more and 15 wt % or less of a thixotropic agent.

Furthermore, the present invention provides a solder paste including a mixture of the flux described above and a solder powder.

Other objects and attainments of the present invention will be become apparent to those skilled in the art upon a reading of the following detailed description.

### DESCRIPTION OF THE INVENTION

### Example of Flux According to the Present Embodiment

A flux according to the present embodiment contains a phenolic activator except a hindered phenol, a resin, an organic acid, and a solvent.

Hindered phenols refer to phenolic compounds having bulky substituents (secondary or higher carbon: for example, t-butyl group) at the ortho position of the carboxyl group (—OH) of phenol.

The phenolic activator is active in a temperature range assumed for soldering. However, hindered phenol phenolic activators have lower activity than other phenolic activators. For this reason, in soldering using a flux containing a hindered phenol phenolic activator, the wetting rate of the solder cannot be improved, so that the desired wetting rate cannot be obtained.

Further, the flux is required to have a high aqueous solution resistivity. A low aqueous solution resistivity of the flux indicates a large amount of ionic substances in the flux. When a metal is joined with solder using a flux, the components in the flux that do not volatilize in the temperature range assumed for soldering remain as flux residues at the joint site. If the amount of the ionic substances in the flux residues is large, the hygroscopicity is high, which leads to the corrosion of the joined metal, resulting in a decrease in reliability. Therefore, the flux is required to have a composition that can increase the aqueous solution resistivity.

Therefore, the flux of the present embodiment contains the phenolic active agent except a hindered phenol in an amount of more than 0 wt % and 30 wt % or less when the total amount of the flux is 100. One or more kinds of phenolic activators except a hindered phenol may be contained. When the flux contains a plurality of kinds of phenolic activators except a hindered phenol, the plurality of kinds phenolic activators except a hindered phenol are contained in a total amount of more than 0 wt % and 30 wt % or less.

The phenolic activator except a hindered phenol may have a molecular weight of less than 150. However, the phenolic activator except a hindered phenol preferably has a molecular weight of 150 or more and 550 or less.

In addition, the phenolic activator having a molecular weight of 150 or more and 550 or less, except a hindered phenol, preferably includes one or more of diallyl bisphenol A, 9,9-bis(4-hydroxy-3-methylphenyl)fluorene and 2,2′,6,6′-tetramethyl-4,4′-(9-fluorenylidene)diphenol. Examples of the phenolic activator having a molecular weight of less than 150 except a hindered phenol include catechol.

Furthermore, the flux according to the present embodiment contains 30 wt % or more and 60 wt % or less of a rosin and 0 wt % or more and 40 wt % or less of an acrylic resin as resins. The resins are contained in a total amount of 30 wt % or more and 60 wt % or less. The flux also contains more than 0 wt % and 10 wt % or less of an organic acid, and the balance is a solvent. When an acrylic resin is further contained, in addition to a rosin, as the resin, the ratio of the acrylic resin to the entire resin consisting of the rosin and the acrylic resin is preferably 0% or more and 80% or less, more preferably 20% or more and 80% or less.

Further, the flux of the present embodiment further contains 0 wt % or more and 20 wt % or less of an amine, 0 wt % or more and 5 wt % or less of a halogen, and 0 wt % or more and 15 wt % or less of a thixotropic agent.

Examples of the rosin as the resin include natural rosins such as gum rosin, wood rosin, and tall oil rosin, and derivatives obtained from the natural rosins. Examples of such rosin derivatives include purified rosins, polymerized rosins, hydrogenated rosins, disproportionated rosins, hydrogenated disproportionated rosins, acid modified rosins, phenol modified rosins, and α,β unsaturated carboxylic acid modified products (acrylated rosins, maleated rosins, fumarated rosins, etc.); purified products, hydrides, disproportionated products, and esterified products of the polymerized rosins; and purified products, hydrides and disproportionated products of the α,β-unsaturated carboxylic acid modified products. One or two or more of these can be used.

In addition to the rosin, an acrylic resin may be further contained as the resin.

Examples of the organic acid include glutaric acid, adipic acid, azelaic acid, eicosan diacid, citric acid, glycolic acid, succinic acid, salicylic acid, diglycolic acid, dipicolinic acid, dibutyl aniline diglycolic acid, suberic acid, sebacic acid, thioglycol acid, isophthalic acid, terephthalic acid, dodecanedioic acid, parahydroxyphenylacetic acid, picolinic acid, phenylsuccinic acid, phthalic acid, fumaric acid, maleic acid, malonic acid, lauric acid, benzoic acid, tartaric acid, tris(2-carboxyethyl)isocyanurate, glycine, 1,3-cyclohexanedicarboxylic acid, 2,2-bis(hydroxymethyl)propionic acid, 2,2-bis(hydroxymethyl)butanoic acid, 2,3-dihydroxybenzoic acid, 2,4-diethyl glutaric acid, 2-quinolinecarboxylic acid, 3-hydroxybenzoic acid, malic acid, p-anisic acid, stearin acid, 12-hydroxystearic acid, oleic acid, linoleic acid, and linolenic acid.

Further, examples of the organic acid include a dimer acid obtained by dimerizing a monocarboxylic acid, a hydrogenated dimer acid which is a hydrogenated product obtained by adding hydrogen to the dimer acid, and a trimer acid obtained by trimerizing a monocarboxylic acid, and a hydrogenated trimer acid which is a hydrogenated product obtained by adding hydrogen to the trimer acid.

Examples of the amine include monoethanolamine, diphenylguanidine, ditolyl guanidine, ethylamine, triethylamine, ethylenediamine, triethylenetetramine, 2-methylimidazole, 2-indecylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimida zolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanuric acid adduct, 2-phenylimidazole isocyanuric acid adduct, 2-phenyl-4,5-dihydroxymethylimidazole, 2-phenyl-4-methyl-5-hydroxymethylimidazole, 2,3-dihydro-1H-pyrrolo [1,2-a]benzimidazole, 1-dodecyl-2-methyl-3-benzylimidazolium chloride, 2-methylimidazoline, 2-phenylimidazoline, 2,4-diamino-6-vinyl-s-triazine, 2,4-diamino-6-vinyl-s-triazine isocyanuric acid adduct, 2,4-diamino-6-methacryloyloxyethyl-s-triazine, epoxy-imidazole adduct, 2-methylbenzimidazole, 2-octylbenzimidazole, 2-pentylbenzimidazole, 2-(1-ethylpentyl)benzimidazole, 2-nonylbenzimidazole, 2-(4-thiazolyl)benzimidazole, benzimidazole, 2-(2′-hydroxy-5′-methylphenyl)benzotriazole, 2-(2′-hydroxy-3′-tert-butyl-5′-methylphenyl)-5-chlorobenzotriazole, 2-(2′-hydroxy-3′,5′-di-tert-amylphenyl)benzotriazole, 2-(2′-hydroxy-5′-tert-octylphenyl)benzotriazole, 2,2′-methylenebis[6-(2H-benzotriazol-2-yl)-4-tert-octylphenol], 6-(2-benzotriazolyl)-4-tert-octyl-6′-tert-butyl-4′-methyl-2,2′-methylene bisphenol, 1,2,3-benzotriazole, 1-[N,N-bis(2-ethylhexyl)aminomethyl]benzotriazole, carboxybenzotriazole, 1-[N,N-bis(2-ethylhexyl)aminomethyl]methyl benzotriazole, 2,2′-[[(methyl-1H-benzotriazol-1-yl)methyl]imino]bisethanol, 1-(1′,2′-dicarboxyethyl)benzotriazole, 1-(2,3-dicarboxypropyl)benzotriazole, 1-[(2-ethylhexylamino) methyl]benzotriazole, 2,6-bis [(1H-benzotriazol-1-yl)methyl]-4-methylphenol, 5-methyl benzotriazole, and 5-phenyltetrazole.

Examples of the halogen include, as organohalogen compounds, trans-2,3-dibromo-2-butene-1,4-diol, trans-2,3-dibromo-1,4-butenediol, triallyl isocyanurate hexabromide, 1-bromo-2-butanol, 1-bromo-2-propanol, 3-bromo-1-propanol, 3-bromo-1,2-propanediol, 1,4-dibromo-2-butanol, 1,3-dibromo-2-propanol, 2,3-dibromo-1-propanol, 2,3-dibromo-1,4-butanediol, and 2,3-dibromo-2-butene-1,4-diol.

The halogen compound may include an amine hydrohalic acid salt. The amine hydrohalic acid salt is a compound obtained by causing an amine and hydrogen halide to react, and includes aniline hydrochloride and aniline hydrobromide. As the amine of the amine hydrohalic acid salt, the above-described amines can be used, and examples thereof include ethylamine, ethylenediamine, triethylamine, methylimidazole, and 2-ethyl-4-methylimidazole. Examples of the hydrogen halide include hydrides of chlorine, bromine, iodine, and fluorine (hydrogen chloride, hydrogen bromide, hydrogen iodide, and hydrogen fluoride). Moreover, a borofluoride may be contained in place of, or in combination with, the amine hydrohalic acid salt, and examples of the borofluoride include fluoroboric acid.

Examples of the solvent include alcohol solvents, glycol ether solvents, and terpineols. Examples of such alcohol solvents include ethanol, industrial ethanol (a mixed solvent obtained by adding methanol and/or isopropyl alcohol to ethanol), isopropyl alcohol, 1,2-butanediol, isobornylcyclohexanol, 2,4-diethyl-1, 5-pentanediol, 2,2-dimethyl-1,3-propanediol, 2,5-dimethyl-2,5-hexanediol, 2,5-dimethyl-3-hexyne-2,5-diol, 2,3-dimethyl-2,3-butanediol, 1,1,1-tris(hydroxymethyl)ethane, 2-ethyl-2-hydroxymethyl-1,3-propanediol, 2,2′-oxybis(methylene)bis(2-ethyl-1,3-propanediol), 2,2-bis(hydroxymethyl)-1,3-propanediol, 1,2,6-trihydroxyhexane, bis[2,2,2-tris(hydroxymethyl)ethyl]ether, 1-ethynyl-1-cyclohexanol, 1,4-cyclohexenediol, 1,4-cyclohexanedimethanol, erythritol, threitol, guaiacol glycerol ether, 3,6-dimethyl-4-octin-3,6-diol, and 2,4,7,9-tetramethyl-5-decyne-4,7-diol. Examples of such glycol ether solvents include hexyl diglycol, diethylene glycol mono-2-ethyl hexyl ether, ethylene glycol monophenyl ether, 2-methylpentane-2,4-diol, diethylene glycol monohexyl ether, diethylene glycol dibutyl ether, triethylene glycol monobutyl ether, and diethyl diglycol ether.

Examples of the thixotropic agent include wax-based thixotropic agents and amide-based thixotropic agents. Examples of such wax-based thixotropic agents include hydrogenated castor oil. Examples of such amide-based thixotropic agents include lauric acid amide, palmitic acid amide, stearic acid amide, behenic acid amide, hydroxystearic acid amide, saturated fatty acid amide, oleic acid amide, erucic acid amide, unsaturated fatty acid amide, p-toluenemethaneamide, aromatic amide, methylene bisstearic acid amide, ethylene bislauric acid amide, ethylene bishydroxystearic acid amide, saturated fatty acid bisamides, methylene bisoleic acid amide, unsaturated fatty acid bisamides, m-xylylene bisstearic acid amides, aromatic bisamides, saturated fatty acid polyamide, unsaturated fatty acid polyamide, aromatic polyamide, substituted amide, methylol stearic acid amide, methylol amide, and fatty acid ester amide.

### Example of Solder Paste of the Present Embodiment

A solder paste of the present embodiment includes the above-described flux and metal powder. The metal powder is preferably Pb-free solder, and is composed of solder powder containing: Sn alone; Sn—Ag, Sn—Cu, Sn—Ag—Cu, Sn—Bi, Sn—In, or the like; or a product obtained by adding Sb, Bi, In, Cu, Zn, As, Ag, Cd, Fe, Ni, Co, Au, Ge, P, or the like to any of these alloys.

### Example of Action/Effect of Flux and Solder Paste of the Present Embodiment

The flux which contains the phenolic activator except a hindered phenol in an amount of more than 0 wt % and 30 wt % or less, when the total amount of the flux is 100; the rosin as the resin in an amount of 30 wt % or more and 60 wt % or less and the acrylic resin as the resin in an amount of 0 wt % or more and 40 wt % or less, the resins being contained in a total amount of 30 wt % or more and 60 wt % or less; and the organic acid in an amount of more than 0 wt % and 10 wt % or less, the balance being a solvent, is active in a temperature range assumed for soldering. In addition, the aqueous solution resistivity is increased.

Thus, the wetting rate of the solder is improved, and the desired wetting rate is obtained. In addition, the hygroscopicity is lowered, the corrosion of the joined metal is suppressed, and the reliability is improved.

### EXECUTED EXAMPLES

Fluxes of Executed Examples and Comparison Examples were prepared with the compositions indicated in Tables 1 and 2 below to verify the wetting rate and the aqueous solution resistivity. The composition percentages in Tables 1 and 2 are expressed in wt (weight) % when the total amount of each flux is 100. In addition, in Tables 1 and 2, the CAS No. of diallyl bisphenol A disclosed as a phenolic activator is 1745-89-7; the CAS No. of 9,9-bis(4-hydroxy-3-methylphenyl)fluorene is 88938-12-9; and the CAS No. of 2,2′,6,6′-tetramethyl-4,4′-(9-fluorenylidene)diphenol is 80850-00-6; and the CAS No. of catechol is 120-80-9. The CAS No. of ethylenebis(oxyethylene)bis[3-(5-tert-butyl-4-hydroxy-m-tolyl)propionate] disclosed as a hindered phenol phenolic activator is 36443-68-2.

### Evaluation of Wetting Rate

### (1) Verification Method

For evaluation of the wetting rate, each of the fluxes was applied to a copper oxide plate to measure the zero cross time by a meniscograph method. The measurement conditions are as follows.

Solid sample: Copper oxide plate, 5 mm in width×25 mm in length, 0.5 mm in thickness, 150° C., 1 h

Solder composition: Sn-3.0Ag-0.5Cu (Sn 96.5 wt %, Ag 3.0 wt %, Cu 0.5 wt %)
Solder bath temperature: 250° C. JIS Z 3198-4
Immersion rate: 5 mm/sec JIS Z 3198-4
Immersion depth: 2 mm JIS Z 3198-4
Measurement time: 10 sec JIS Z 3198-4
Amount of flux applied: Each of the fluxes was applied with a needle point so that the flux covered the surface of the copper oxide plate to an immersion depth of 3 mm of the copper oxide plate.

### (2) Criterion of Determination

○: The zero cross time value was 2.5 seconds or less.
x: The zero cross time value was more than 2.5 seconds.

### Evaluation of Aqueous Solution Resistivity

### (1) Verification Method

For evaluation of the aqueous solution resistivity, the fluxes of Executed Examples and Comparison Examples were diluted with isopropyl alcohol, and the diluted products were used as liquid samples. When the total amount of each of the samples is 100, the amount of the flux is 25 wt %, and the amount of isopropyl alcohol is 75 wt %. Each of the samples was used to measure the aqueous solution resistivity in accordance with JIS Z 3197 8.1.1.

### (2) Criterion of Determination

○: The aqueous solution resistivity was 500 Ωm or more
x: The aqueous solution resistivity was less than 500 Ωm

### Comprehensive Evaluation

○: Both the wetting rate and the aqueous solution resistivity were evaluated as ○
x: Either one or both of the wetting rate and the aqueous solution resistivity was/were evaluated as x

TABLE 1

| | | Molecular | | Executed | Executed | Executed | Executed | Executed | Executed | Executed |
|---|---|---|---|---|---|---|---|---|---|---|
| Category | Reagent name | weight | CAS No | Example 1 | Example 2 | Example 3 | Example 4 | Example 5 | Example 6 | Example 7 |
| Phenolic | Diallyl bisphenol A | 308.41 | 1745-89-7 | 5 | 3 | 10 | 20 | 1 | | |
| activator | 9,9-Bis(4-hydroxy-3- | 378.47 | 88938-12-9 | | 1 | | | | 5 | 10 |
| | methylphenyl)fluorene | | | | | | | | | |
| | 2,2′,6,6′- | 406.51554 | 80850-00-6 | | 1 | | | | | |
| | Tetramethyl-4,4′-(9- | | | | | | | | | |
| | fluorenylidene)diphenol | | | | | | | | | |
| | Catechol | 110.1 | 120-80-9 | | | | | | | |
| | Ethylenebis(oxyethyl- | 586.76 | 36443-68-2 | | | | | | | |
| | ene)bis[3-(5-tert- | | | | | | | | | |
| | butyl-4-hydroxy-m- | | | | | | | | | |
| | tolyl)propionate] | | | | | | | | | |
| Resin | Resin | | | 40 | 40 | 40 | 40 | 40 | 40 | 40 |
| | Acrylic resin | | | | | | | | | |
| Organic | Adipic acid | | | 5 | 5 | 5 | 5 | 5 | 5 | 5 |
| acid | Glutaric acid | | | | | | | | | |
| | Azelaic acid | | | | | | | 4 | | 4 |
| Amine | 2-Ethyl-4- | | | 3 | 3 | 3 | 3 | 3 | 3 | 3 |
| | methylimidazole | | | | | | | | | |
| | 2-Undecylimidazole | | | | | | | | | |
| | Diethanolamine | | | | | | | | | |
| Halogen | Trans-2,3-dibromo-2- | | | 1 | 1 | 1 | 1 | 1 | 1 | 1 |
| | butene-1,4-diol | | | | | | | | | |
| | Triailyl Isocyanurate | | | | | | | | | |
| | hexabromide | | | | | | | | | |
| Solvent | Hexyl diglycol | | | Bal | Bal | Bal | Bal | Bal | Bal | Bal |
| | Tetraethylene glycol | | | | | | | | | |
| | dimethyl ether | | | | | | | | | |
| Thixotropic | Hydrogenated castor | | | 6 | 6 | 6 | 6 | 6 | 5 | 6 |
| agent | oil | | | | | | | | | |

| | | | | | | | | |
|---|---|---|---|---|---|---|---|---|
| Evaluation | Wetting rate | ◯ | ◯ | ◯ | ◯ | ◯ | ◯ | ◯ |
| item | Aqueous solution resistivity | ◯ | ◯ | ◯ | ◯ | ◯ | ◯ | ◯ |
| | Comprehensive evaluation | ◯ | ◯ | ◯ | ◯ | ◯ | ◯ | ◯ |

| | | Molecular | | Executed | Executed | Executed | Executed | Executed | Executed |
|---|---|---|---|---|---|---|---|---|---|
| Category | Reagent name | weight | CAS No | Example 8 | Example 9 | Example 10 | Example 11 | Example 12 | Example 13 |
| Phenolic | Diallyl bisphenol A | 308.41 | 1745-89-7 | | | 5 | 5 | 5 | 5 |
| activator | 9,9-Bis(4-hydroxy-3- | 378.47 | 88936-12-9 | | | | | | |
| | methylphenyl)fluorene | | | | | | | | |
| | 2,2′,6,6′- | 406.51554 | 80850-00-6 | 5 | | | | | |
| | Tetramethyl-4,4′-(9- | | | | | | | | |
| | fluorenylidene)diphenol | | | | | | | | |
| | Catechol | 110.1 | 120-80-9 | | 5 | | | | |
| | Ethylenebis(oxyethyl- | 586.76 | 36443-68-2 | | | | | | |
| | ene)bis[3-(5-tert- | | | | | | | | |
| | butyl-4-hydroxy-m- | | | | | | | | |
| | tolyl)propionate] | | | | | | | | |
| Resin | Resin | | | 40 | 40 | 30 | 60 | 40 | 40 |
| | Acrylic resin | | | | | | | | |
| Organic | Adipic acid | | | 5 | 5 | 5 | 5 | 10 | 2 |
| acid | Glutaric acid | | | 1 | | | | | 2 |
| | Azelaic acid | | | | | | | | 2 |
| Amine | 2-Ethyl-4- | | | 3 | 3 | 3 | 3 | 3 | 3 |
| | methylimidazole | | | | | | | | |
| | 2-Undecylimidazole | | | | | | | | |
| | Diethanolamine | | | | | | | | |
| Halogen | Trans-2,3-dibromo-2- | | | 1 | 1 | 1 | 1 | 1 | 1 |
| | butene-1,4-diol | | | | | | | | |
| | Triailyl Isocyanurate | | | | | | | | |
| | hexabromide | | | | | | | | |
| Solvent | Hexyl diglycol | | | Bal | Bal | Bal | Bal | Bal | Bal |
| | Tetraethylene glycol | | | | | | | | |
| | dimethyl ether | | | | | | | | |
| Thixotropic | Hydrogenated castor | | | 6 | 6 | 15 | 0 | 6 | 6 |
| agent | oil | | | | | | | | |

| | | | | | | | |
|---|---|---|---|---|---|---|---|
| Evaluation | Wetting rate | ◯ | ◯ | ◯ | ◯ | ◯ | ◯ |
| item | Aqueous solution resistivity | ◯ | ◯ | ◯ | ◯ | ◯ | ◯ |
| | Comprehensive evaluation | ◯ | ◯ | ◯ | ◯ | ◯ | ◯ |

TABLE 2

| | | | | Executed | Executed | Executed | Executed | Executed | Executed | Executed |
|---|---|---|---|---|---|---|---|---|---|---|
| | | Molecular | | Example | Example | Example | Example | Example | Example | Example |
| Category | Reagent name | weight | CAS No | 14 | 15 | 16 | 17 | 18 | 19 | 20 |
| Phenolic | Diallyl bisphenol A | 308.41 | 1745-89-7 | | | | 5 | 5 | 5 | 5 |
| activator | 9,9-Bis(4-hydroxy-3- | 378.47 | 88936-12-9 | 5 | 5 | 5 | | | | |
| | methylphenyl)fluorene | | | | | | | | | |
| | 2,2′,6,6′- | 406.51554 | 80850-00-6 | | | | | | | |
| | Tetramethyl-4,4′-(9- | | | | | | | | | |
| | fluorenylidene)diphenol | | | | | | | | | |
| | Catechol | 110.1 | 120-80-9 | | | | | | | |
| | Ethylenebis(oxyethyl- | 586.76 | 36443-68-2 | | | | | | | |
| | ene)bis[3-(5-tert- | | | | | | | | | |
| | butyl-4-hydroxy-m- | | | | | | | | | |
| | tolyl)propionate] | | | | | | | | | |
| Resin | Resin | | | 40 | 40 | 40 | 8 | 16 | 24 | 32 |
| | Acrylic resin | | | | | | 32 | 24 | 16 | 8 |
| Organic | Adipic acid | | | 5 | 5 | 5 | 5 | 5 | 5 | 5 |
| acid | Glutaric acid | | | | | | | | | |
| | Azelaic acid | | | | | | | | | |
| Amine | 2-Ethyl-4- | | | 20 | 1 | 3 | 3 | 3 | 3 | 3 |
| | methylimidazole | | | | | | | | | |
| | 2-Undecylimidazole | | | | 1 | | | | | |
| | Diethanolamine | | | | 1 | | | | | |
| Halogen | Trans-2,3-dibromo-2- | | | 0 | 1 | 2.5 | 1 | 1 | 1 | 1 |
| | butene-1,4-diol | | | | | | | | | |
| | Triailyl isocyanurate | | | | | 2.5 | | | | |
| | hexabromide | | | | | | | | | |
| Solvent | Hexyl diglycol | | | | | | Bal | Bal | Bal | Bal |
| | Tetraethylene glycol | | | Bal | Bal | Bal | | | | |
| | dimethyl ether | | | | | | | | | |
| Thixotropic | Hydrogenated castor | | | 6 | 6 | 6 | 6 | 6 | 6 | 6 |
| agent | oil | | | | | | | | | |
| Evaluation | Wetting rate | | | | ◯ | ◯ | ◯ | ◯ | ◯ | ◯ |
| item | Aqueous solution resistivity | | | | ◯ | ◯ | ◯ | ◯ | ◯ | ◯ |
| | Comprehensive evaluation | | | | ◯ | ◯ | ◯ | ◯ | ◯ | ◯ |
| | | | | | | | | Compar- | Compar- | Compar- |
| | | | | Executed | Executed | Executed | Executed | ison | ison | ison |
| | | Molecular | | Example | Example | Example | Example | Example | Example | Example |
| Category | Reagent name | weight | CAS No | 21 | 22 | 23 | 24 | 1 | 2 | 3 |
| Phenolic | Diallyl bisphenol A | 308.41 | 1745-89-7 | | | | | | | |
| activator | 9,9-Bis(4-hydroxy-3- | 378.47 | 88938-12-9 | 5 | 5 | 5 | 5 | | | |
| | methylphenyl)fluorene | | | | | | | | | |
| | 2,2′,6,6′- | 406.51554 | 80850-00-6 | | | | | | | |
| | Tetramethyl-4,4′-(9- | | | | | | | | | |
| | fluorenylidene)diphenol | | | | | | | | | |
| | Catechol | 110.1 | 120-80-9 | | | | | | | |
| | Ethylenebis(oxyethyl- | 586.76 | 36443-68-2 | | | | | | | 5 |
| | ene)bis[3-(5-tert- | | | | | | | | | |
| | butyl-4-hydroxy-m- | | | | | | | | | |
| | tolyl)propionate | | | | | | | | | |
| Resin | Rosin | | | 32 | 24 | 16 | 8 | 40 | 40 | 40 |
| | Acrylic resin | | | 8 | 16 | 24 | 32 | | | |
| Organic | Adipic acid | | | 5 | 5 | 5 | 5 | 5 | 5 | |
| acid | Glutaric acid | | | | | | | 5 | | 5 |
| | Azelaic acid | | | | | | | | | |
| Amine | 2-Ethyl-4- | | | 3 | 3 | 3 | 3 | 3 | 3 | 3 |
| | methylimidazole | | | | | | | | | |
| | 2-Undecylimidazole | | | | | | | | | |
| | Diethanolamine | | | | | | | | | |
| Halogen | Trans-2,3-dibromo-2- | | | 1 | 1 | 1 | 1 | 1 | 1 | 1 |
| | butene-1,4-diol | | | | | | | | | |
| | Triailyl isocyanurate | | | | | | | | | |
| | hexabromide | | | | | | | | | |
| Solvent | Hexyl diglycol | | | Bal | Bal | Bal | Bal | Bal | Bal | Bal |
| | Tetraethylene glycol | | | | | | | | | |
| | dimethyl ether | | | | | | | | | |
| Thixotropic | Hydrogenated castor | | | 6 | 6 | 6 | 6 | 6 | 6 | 6 |
| agent | oil | | | | | | | | | |

| | | | | | | | | |
|---|---|---|---|---|---|---|---|---|
| Evaluation | Wetting rate | ◯ | ◯ | ◯ | ◯ | X | X | ◯ |
| item | Aqueous solution resistivity | ◯ | ◯ | ◯ | ◯ | X | ◯ | X |
| | Comprehensive evaluation | ◯ | ◯ | ◯ | ◯ | X | X | X |

As for Executed Example 1 containing: as a phenolic activator, diallyl bisphenol A having a molecular weight of 308.41 in an amount of 5 wt % within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 2 containing: as phenolic activators, diallyl bisphenol A having a molecular weight of 308.41 in an amount of 3 wt % within the range defined in the present invention, 9,9-bis(4-hydroxy-3-methylphenyl)fluorene having a molecular weight of 378.47 in an amount of 1 wt % within the range defined in the present invention, and 2,2′,6,6′-tetramethyl-4,4′-(9-fluorenylidene)diphenol having a molecular weight of 406.51554 in an amount of 1 wt % within the range defined in the present invention, the total amount of phenolic activators except a hindered phenol falling within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 3 containing: as a phenolic activator, diallyl bisphenol A having a molecular weight of 308.41 in an amount of 10 wt % within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 4 containing: as a phenolic activator, diallyl bisphenol A having a molecular weight of 308.41 in an amount of 20 wt % within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 5 containing: as a phenolic activator, diallyl bisphenol A having a molecular weight of 308.41 in an amount of 1 wt % within the range defined in the present invention; as a resin, a rosin in an amount of 40 wt % within the range defined in the present invention; as organic acids, adipic acid in an amount of 5 wt % within the range defined in the present invention and azelaic acid in an amount of 4 wt % within the range defined in the present invention, the total amount of organic acids falling within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 6 containing: as a phenolic activator, 9,9-bis(4-hydroxy-3-methylphenyl)fluorene having a molecular weight of 378.47 in an amount of 5 wt % within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 7 containing: as a phenolic activator, 9,9-bis(4-hydroxy-3-methylphenyl)fluorene having a molecular weight of 378.47 in an amount of 10 wt % within the range defined in the present invention; as a resin, a rosin in an amount of 40 wt % within the range defined in the present invention; as organic acids, adipic acid in an amount of 5 wt % within the range defined in the present invention and azelaic acid in an amount of 4 wt % within the range defined in the present invention, the total amount of organic acids falling within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 8 containing: as a phenolic activator, 2,2′,6,6′-tetramethyl-4,4′-(9-fluorenylidene)diphenol having a molecular weight of 406.51554 in an amount of 5 wt % within the range defined in the present invention; as a resin, a rosin in an amount of 40 wt % within the range defined in the present invention; as organic acids, adipic acid in an amount of 5 wt % within the range defined in the present invention and glutaric acid in an amount of 1 wt % within the range defined in the present invention, the total amount of organic acids falling within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 9 containing: as a phenolic activator, catechol having a molecular weight of 110.1 in an amount of 5 wt % within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 10 containing: as a phenolic activator, diallyl bisphenol A having a molecular weight of 308.41 in an amount of 5 wt % within the range defined in the present invention; as a resin, a rosin in an amount of 30 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 15 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 11 containing: as a phenolic activator, diallyl bisphenol A having a molecular weight of 308.41 in an amount of 5 wt % within the range defined in the present invention; as a resin, a rosin in an amount of 60 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and no thixotropic agent, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 12 containing: as a phenolic activator, diallyl bisphenol A having a molecular weight of 308.41 in an amount of 5 wt % within the range defined in the present invention; as a resin, a rosin in an amount of 40 wt % within the range defined in the present invention; as an organic acid, adipic acid in an amount of 10 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 13 containing: as a phenolic activator, diallyl bisphenol A having a molecular weight of 308.41 in an amount of 5 wt % within the range defined in the present invention; as a resin, a rosin in an amount of 40 wt % within the range defined in the present invention; as organic acids, adipic acid in an amount of 2 wt % within the range defined in the present invention, glutaric acid in an amount of 2 wt % in the range defined in the present invention, and azelaic acid in an amount of 2 wt % within the range defined in the present invention, the total amount of organic acids falling within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 14 containing: as a phenolic activator, 9,9-bis(4-hydroxy-3-methylphenyl)fluorene having a molecular weight of 378.47 in an amount of 5 wt % within the range defined in the present invention; as a resin, a rosin in an amount of 40 wt % within the range defined in the present invention; as an organic acid, adipic acid in an amount of 5 wt % within the range defined in the present invention; and further, as an amine, 2-ethyl-4-methylimidazole in an amount of 20 wt % within the range defined in the present invention; no halogen; and, as a thixotropic agent, hydrogenated castor oil in an amount of 6 wt % within the range defined in the present invention, the balance being tetraethylene glycol dimethyl ether as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 15 containing: 9,9-bis(4-hydroxy-3-methylphenyl)fluorene having a molecular weight of 378.47 in an amount of 5 wt % within the range defined in the present invention; as a resin, a rosin in an amount of 40 wt % within the range defined in the present invention; as an organic acid, adipic acid in an amount of 5 wt % within the range defined in the present invention; further, as amines, 2-ethyl-4-methylimidazole in an amount of 1 wt % within the range defined in the present invention, 2-undecylimidazole in an amount of 1 wt % within the range defined in the present invention, and diethanolamine in an amount of 1 wt % within the range defined in the present invention, the total amount of the amines falling within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being tetraethylene glycol dimethyl ether as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 16 containing: as a phenolic activator, 9,9-bis(4-hydroxy-3-methylphenyl)fluorene having a molecular weight of 378.47 in an amount of 5 wt % within the range defined in the present invention; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as halogens, an organohalogen compound, trans-2,3-dibromo-2-butene-1,4-diol in an amount of 2.5 wt % within the range defined in the present invention and an organohalogen compound, triallyl isocyanurate hexabromide in an amount of 2.5 wt % within the range defined in the present invention, the total amount of halogens falling within the range defined in the present invention; and, as a thixotropic agent, hydrogenated castor oil in an amount of 6 wt % within the range defined in the present invention, the balance being tetraethylene glycol dimethyl ether as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 17 containing: as a phenolic activator, diallyl bisphenol A having a molecular weight of 308.41 in an amount of 5 wt % within the range defined in the present invention; as resins, a rosin in an amount of 8 wt % within the range defined in the present invention and an acrylic resin in an amount of 32 wt % within the range defined in the present invention, the total amount of resins falling within the range defined in the present invention and the ratio of the acrylic resin to the entire resin consisting of the rosin and the acrylic resin being 80% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 18 containing: as a phenolic activator, diallyl bisphenol A having a molecular weight of 308.41 in an amount of 5 wt % within the range defined in the present invention; as resins, a rosin in an amount of 16 wt % within the range defined in the present invention and an acrylic resin in an amount of 24 wt % within the range defined in the present invention, the total amount of resins falling within the range defined in the present invention and the ratio of the acrylic resin to the entire resin consisting of the rosin and the acrylic resin being 60% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 19 containing: as a phenolic activator, diallyl bisphenol A having a molecular weight of 308.41 in an amount of 5 wt % within the range defined in the present invention; as resins, a rosin in an amount of 24 wt % within the range defined in the present invention and an acrylic resin in an amount of 16 wt % within the range defined in the present invention, the total amount of resins falling within the range defined in the present invention and the ratio of the acrylic resin to the entire resin consisting of the rosin and the acrylic resin being 40% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 20 containing: as a phenolic activator, diallyl bisphenol A having a molecular weight of 308.41 in an amount of 5 wt % within the range defined in the present invention; as resins, a rosin in an amount of 32 wt % within the range defined in the present invention and an acrylic resin in an amount of 8 wt % within the range defined in the present invention, the total amount of resins falling within the range defined in the present invention and the ratio of the acrylic resin to the entire resin consisting of the rosin and the acrylic resin being 20% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 21 containing: as a phenolic activator, 9,9-bis(4-hydroxy-3-methylphenyl)fluorene having a molecular weight of 378.47 in an amount of 5 wt % within the range defined in the present invention; as resins, a rosin in an amount of 32 wt % within the range defined in the present invention and an acrylic resin in an amount of 8 wt % within the range defined in the present invention, the total amount of resins falling within the range defined in the present invention and the ratio of the acrylic resin to the entire resin consisting of the rosin and the acrylic resin being 20% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 22 containing: as a phenolic activator, 9,9-bis(4-hydroxy-3-methylphenyl)fluorene having a molecular weight of 378.47 in an amount of 5 wt % within the range defined in the present invention; as resins, a rosin in an amount of 24 wt % within the range defined in the present invention and an acrylic resin in an amount of 16 wt % within the range defined in the present invention, the total amount of resins falling within the range defined in the present invention and the ratio of the acrylic resin to the entire resin consisting of the rosin and the acrylic resin being 40% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 23 containing: as a phenolic activator, 9,9-bis(4-hydroxy-3-methylphenyl)fluorene having a molecular weight of 378.47 in an amount of 5 wt % within the range defined in the present invention; as resins, a rosin in an amount of 16 wt % within the range defined in the present invention and an acrylic resin in an amount of 24 wt % within the range defined in the present invention, the total amount of resins falling within the range defined in the present invention and the ratio of the acrylic resin to the entire resin consisting of the rosin and the acrylic resin being 60% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

Also as for Executed Example 24 containing: as a phenolic activator, 9,9-bis(4-hydroxy-3-methylphenyl)fluorene having a molecular weight of 378.47 in an amount of 5 wt % within the range defined in the present invention; as resins, a rosin in an amount of 8 wt % within the range defined in the present invention and an acrylic resin in an amount of 32 wt % within the range defined in the present invention, the total amount of resins falling within the range defined in the present invention and the ratio of the acrylic resin to the entire resin consisting of the rosin and the acrylic resin being 80% within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. Moreover, the aqueous solution resistivity met the criterion of determination described above, and a sufficient effect on the aqueous solution resistivity was obtained.

On the other hand, as for Comparison Example 1 containing: no phenolic activator; as a resin, a rosin in an amount of 40 wt % within the range defined in the present invention; as organic acids, adipic acid in an amount of 5 wt % within the range defined in the present invention and glutaric acid in an amount of 5 wt % within the range defined in the present invention, the total amount of organic acids falling within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate did not meet the above-described criterion of determination, and no effect on the wetting rate was obtained. Moreover, the aqueous solution resistivity did not meet the criterion of determination described above, and no effect on the aqueous solution resistivity was obtained.

In addition, as for Comparison Example 2 containing: no phenolic activator; as a resin, a rosin in an amount of 40 wt % within the range defined in the present invention; as an organic acid, adipic acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the aqueous solution resistivity met the above-described criterion of determination, and a sufficient effect on the aqueous solution resistivity was obtained. However, the wetting rate did not meet the criterion of determination described above, and no effect was obtained on the wetting rate.

Further, as for Comparison Example 3 containing: as a hindered phenol phenolic activator, ethylenebis(oxyethylene)bis[3-(5-tert-butyl-4-hydroxy-m-tolyl)propionate] having a molecular weight of 586.76 in an amount of 5 wt % outside the range defined in the present invention; as an organic acid, glutaric acid in an amount of 5 wt % within the range defined in the present invention; further, as an amine, 2-ethyl-4-methylimidazole in an amount of 3 wt % within the range defined in the present invention; as a halogen, an organohalogen compound, trans-2,3-dibromo-2-butene-1,4-diol in an amount of 1 wt % within the range defined in the present invention; and, as a thixotropic agent, hydrogenated castor oil in an amount of 6 wt % within the range defined in the present invention, the balance being hexyl diglycol as a solvent, the wetting rate met the above-described criterion of determination, and a sufficient effect on the wetting rate was obtained. However, the aqueous solution resistivity did not meet the criterion of determination described above, and no effect on the aqueous solution resistivity was obtained.

In view of the above, a flux containing: a phenolic activator except a hindered phenol in an amount of more than 0 wt % and 30 wt % or less when the total amount of the flux is 100; as resins, a rosin in an amount of 30 wt % or more and 60 wt % or less and an acrylic resin in an amount of 0 wt % or more and 40 wt % or less, the resins being contained in a total amount of 30 wt % or more and 60 wt % or less; and an organic acid in an amount of more than 0 wt % and 10 wt % or less, the balance being a solvent, and a solder paste using the flux composition provided a sufficient effect on the wetting rate of solder. In addition, a sufficient effect on the aqueous solution resistivity was obtained.

These effects were not inhibited by inclusion of an amine, a halogen, and a thixotropic agent within the ranges defined in the present invention.

It is to be noted that any technical scope of the claims and/or meaning of term(s) claimed in the claims are not limited to the description in the above-mentioned embodiments. It should be understood by those skilled in the art that various modifications, combinations, sub-combinations and alterations may occur depending on design requirements and other factors insofar as they are within the scope of the appended claims or the equivalents thereof.

What is claimed is:

1. A flux comprising:
a) a phenolic activator having a molecular weight of 150 or more and 550 or less except a hindered phenol or p-nonylphenol,
b) a resin,
c) an organic acid, and
d) a solvent,
wherein the phenolic activator is contained in an amount of 1 wt% or more and 30 wt% or less;
the resin consists of a rosin and an acrylic resin, wherein the rosin is contained in an amount of 30 wt % or more and 60 wt % or less, the acrylic resin is contained in an amount of 0 wt % or more and 40 wt % or less, and the resin is contained in an amount of 30 wt % or more and 60 wt % or less; and
the organic acid is contained in an amount of 0 wt % or more and 10 wt % or less.

2. The flux according to claim 1, wherein the weight ratio of the acrylic resin to the resin consisting of the rosin and the acrylic resin is 0% or more and 80% or less.

3. A flux comprising:
a) a phenolic activator except a hindered phenol, and
b) resin consisting of rosin and an acrylic resin,
wherein the phenolic activator is contained in an amount of 1 wt % or more and 30 wt % or less;
the acrylic resin is contained in an amount of 0 wt% or more and 40 wt% or less;
the resin is contained in an amount of 30 wt% or more and 60 wt% or less;
the weight ratio of the acrylic resin to the resin consisting of the rosin and the acrylic resin is 20% or more and 80% or less; and
the organic acid is contained in an amount of 0 wt % or more and 10 wt % or less.

4. The flux according to claim 3, wherein the rosin is contained in an amount of 30 wt % or more and 60 wt % or less.

5. The flux according to claim 1, wherein the phenolic activator includes one or more of diallyl bisphenol A, 9,9-bis(4-hydroxy-3-methylphenyl)fluorene and 2,2′,6,6′-tetramethyl-4,4′-(9-fluorenylidene)diphenol.

6. The flux according to claim 2, wherein the phenolic activator includes one or more of diallyl bisphenol A, 9,9-bis(4-hydroxy-3-methylphenyl)fluorene and 2,2′,6,6′-tetramethyl-4,4′-(9-fluorenylidene)diphenol.

7. The flux according to claim 3, wherein the phenolic activator includes one or more of diallyl bisphenol A, 9,9-bis(4-hydroxy-3-methylphenyl)fluorene and 2,2′,6,6′-tetramethyl-4,4′-(9-fluorenylidene)diphenol.

8. The flux according to claim 4, wherein the phenolic activator includes one or more of diallyl bisphenol A, 9,9-bis(4-hydroxy-3-methylphenyl)fluorene and 2,2′,6,6′-tetramethyl-4,4′-(9-fluorenylidene)diphenol.

9. The flux according to claim 1, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

10. The flux according to claim 2, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

11. The flux according to claim 3, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

12. The flux according to claim 4, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

13. The flux according to claim 5, which further comprises: 0 wt % or more and 20 wt % or less of an amine; 0 wt % or more and 5 wt % or less of at least one of an organohalogen compound and an amine hydrohalic acid saltt; and 0 wt % or more and 15 wt % or less of a thixotropic agent.

14. The flux according to claim 6, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

15. The flux according to claim 7, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

16. The flux according to claim 8, which further comprises: 0 wt % or more and 20 wt % or less of an amine; 0 wt % or more and 5 wt % or less of at least one of an organohalogen compound and an amine hydrohalic acid salt; and 0 wt % or more and 15 wt % or less of a thixotropic agent.

17. A solder paste comprising a mixture of the flux according to claim 1 and a solder powder.

18. A solder paste comprising a mixture of the flux according to claim 3 and a solder powder.
